(19) United States
(12) Patent Application Publication
(10) Pub. No.: US 2026/0270995 A1
(43) Pub. Date: Sep. 10, 2026

(54) RESOURCE CONFLICT RESOLUTION FOR CONTROL RESOURCE SELECTION

(71) Applicant: QUALCOMM Incorporated, San Diego, CA (US)

(72) Inventors: Gabi SARKIS, San Diego, CA (US); Dalton James JONES, Cupertino, CA (US); Pierre-David LETOURNEAU, Austin, TX (US); Matthew Harper LANGSTON, Beacon, NY (US)

(21) Appl. No.: 19/070,458

(22) Filed: Mar. 4, 2025

(51) Int. Cl. H04W 72/20; H04W 72/02; H04W 72/12; H04W 72/563

(52) U.S. Cl. CPC H04W 72/20; H04W 72/02; H04W 72/12; H04W 72/563

(57) ABSTRACT

Various aspects of the present disclosure generally relate to wireless communication. In some aspects, a network node may transmit, to a set of user equipments (UEs), configuration information that configures a control region associated with control message transmissions to the set of UEs. The network node may perform a scheduling procedure to schedule one or more UEs of the set of UEs, respectively, with one or more control messages in accordance with one or more scheduling conflict rules, where the one or more scheduling conflict rules may be associated with identifying whether there is candidate resource overlap for the one or more control messages within the control region. The network node may transmit the one or more control messages, respectively, to the one or more UEs in accordance with the one or more scheduling conflict rules. Numerous other aspects are described.

### FIELD OF THE DISCLOSURE

Aspects of the present disclosure generally relate to wireless communication and specifically relate to techniques, apparatuses, and methods associated with resource conflict resolution for control resource selection.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

In some examples of wireless communications, a network node may communicate control messages to one or more user equipments (UEs) serviced by the network node. In some examples, the network node may transmit a set of control messages respectively to a set of UEs via resources of a control region. For example, a control region may be a designated area within the time-frequency resource grid used for transmitting control messages. The allocation of control resources within the control region may defined by a control resource set (CORESET) and a search space. For example, the CORESET may specify the time and frequency domain resources where the control messages may be transmitted, determining how control messages are structured and scheduled. Within this CORESET, the search space may define a set of candidate locations where a given UE may expect to receive a control message.

### SUMMARY

The systems, methods, and devices of this disclosure each have several innovative aspects, no single one of which is solely responsible for the desirable attributes disclosed herein.

Some aspects described herein relate to a network node for wireless communication. The network node may include a processing system. The processing system may include one or more processors and one or more code-storing memories coupled with the one or more processors. The processing system may be configured to cause the network node to transmit, to a set of user equipments (UEs), configuration information that configures a control region associated with control message transmissions to the set of UEs. The processing system may be configured to cause the network node to perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region. The processing system may be configured to cause the network node to transmit the one or more control messages, respectively, to the one or more UEs in accordance with the one or more scheduling conflict rules.

Some aspects described herein relate to a method of wireless communication performed by a network node. The method may include transmitting, to a set of UEs, configuration information that configures a control region associated with control message transmissions to the set of UEs. The method may include performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region. The method may include transmitting the one or more control messages, respectively, to the one or more UEs in accordance with the one or more scheduling conflict rules.

Some aspects described herein relate to a non-transitory computer-readable medium that stores a set of instructions for wireless communication by a network node. The set of instructions, when executed by one or more processors of the network node, may cause the network node to transmit, to a set of UEs, configuration information that configures a control region associated with control message transmissions to the set of UEs. The set of instructions, when executed by one or more processors of the network node, may cause the network node to perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region. The set of instructions, when executed by one or more processors of the network node, may cause the network node to transmit the one or more control messages, respectively, to the one or more UEs in accordance with the one or more scheduling conflict rules.

Some aspects described herein relate to an apparatus for wireless communication. The apparatus may include means for transmitting, to a set of UEs, configuration information that configures a control region associated with control message transmissions to the set of UEs. The apparatus may include means for performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region. The apparatus may include means for transmitting the one or more control messages, respectively, to the one or more UEs in accordance with the one or more scheduling conflict rules.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example resource structure for wireless communication.

FIG. 4 is a diagram illustrating an example of candidate position generation for transmission of one or more control messages.

FIG. 5 is a diagram illustrating an example of candidate position generation for transmission of one or more control messages with conflicting resources.

FIG. 6 is a diagram illustrating an example associated with resource conflict resolution between multiple control messages using linear programming.

FIG. 7 is a diagram illustrating an example associated with resource conflict resolution between multiple control messages using linear programming.

FIG. 8 is a diagram illustrating an example associated with operations that enable resource conflict resolution for control resource selection.

FIG. 9 is a diagram illustrating an example process performed, for example, at a network node or an apparatus of a network node.

FIG. 10 is a diagram of an example apparatus for wireless communication.

### DETAILED DESCRIPTION

In some examples of wireless communications, a network node may communicate control messages (e.g., one or more physical downlink control channel (PDCCH) messages or one or more physical downlink shared channel (PDSCH) messages) to one or more user equipments (UEs) serviced by the network node. In some examples, the network node may transmit a set of control messages respectively to a set of UEs via resources of a control region. For example, a control region may be a designated area within the time-frequency resource grid used for transmitting control messages. The allocation of control resources within the control region may defined by a control resource set (CORESET) and a search space. For example, the CORESET may specify the time and frequency domain resources where the control messages may be transmitted, determining how control messages are structured and scheduled. Within this CORESET, the search space may define a set of candidate locations where a given UE may expect to receive a control message. Because a given UE may not be configured with prior knowledge of an exact position within the control region to receive a control message, the given UE may perform blind decoding within the control region to monitor for a control message. For example, the given UE may use information associated with communications with the network node to calculate one or more candidate positions within the control region to monitor for the control messages. Accordingly, the set of UEs may each be associated with one or more respective candidate positions to monitor for control messages from the network node during a time interval (e.g., during a slot).

To reduce interference between transmission of multiple control messages, the network node may select a combination of multiple candidate positions within the control region that are respectively associated with the multiple control messages that reduces the overlap of resources between the multiple candidate positions. However, determining a valid combination of candidate positions may increase in time and complexity as one or more of a number of control messages or a number of possible candidates per control message increases. Such increases in time and complexity may increase latency associated with wireless transmissions and increase power expenditure at the network node. Additionally, or alternatively, there may be cases where there is no way for the network node to schedule multiple control messages without an overlap in resources within the control region. If the network node transmits two control messages that are respectively associated with two candidate positions that share overlapping resources, then the overlap in resources may increase interference between the two control messages, reducing a likelihood of successful reception or decoding by the receiving UEs. Alternatively, if the network node determines to drop one of the two control messages (to reduce interference), the network node may be unaware of a procedure to determine which of the two control messages to prioritize for transmission, increasing complexity at the network node for control message scheduling.

Various aspects relate generally to a network node performing resource conflict resolution for control resource selection. Some aspects specifically relate to the network node performing a scheduling procedure to schedule one or more UEs respectively with one or more control messages in accordance with one or more scheduling conflict rules. For instance, the scheduling procedure and the one or more scheduling conflict rules may be associated with or part of a combinatorial algorithm that the network node uses to determine how to maximize a number of control messages transmitted via the control region while reducing the candidate resource overlap between the control messages. In some examples, the scheduling procedure and the one or more scheduling conflict rules may be associated with a backtracking algorithm. In some examples, the scheduling procedure and the one or more scheduling conflict rules may be associated with a satisfiability algorithm (e.g., a constraint programing-satisfiability (CP-SAT) solver). In some examples, the scheduling procedure and the one or more scheduling conflict rules may be associated with one or more fairness metrics for resource selection in the control region.

Particular aspects of the subject matter described in this disclosure can be implemented to realize one or more of the following potential advantages. In some examples, the described techniques can be used to reduce complexity in determining a valid scheduling for the transmission of multiple control messages in a control region. For example, the network node may use the backtracking algorithm based on an ease of implementation. For example, the network node may use a number of instructions (such as a number of lines of code) to perform the backtracking algorithm, where the number of instructions satisfies or is below a number threshold. Accordingly, the amount of storage space used to store and perform the backtracking algorithm may be low, which may reduce memory allocation at the network node for performing resource conflict resolution in the control region. In some examples, the described techniques can be used to reduce latency associated with determining a valid scheduling scheme for the transmission of multiple control messages in a control region. For example, the network node may use the satisfiability algorithm based on the satisfiability algorithm being associated with a reduced processing duration compared to other combinatorial algorithms. Accordingly, the satisfiability algorithm may reduce latency at the network node in performing resource conflict resolution in the control region. In some examples, the described techniques can be used to prioritize how the network node schedules control messages. For example, by using the one or more fairness metrics the network node may respectively weight the importance of transmitting multiple control messages, which enable the network node to prioritize transmission of control messages that may increase resource utilization of the control region.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

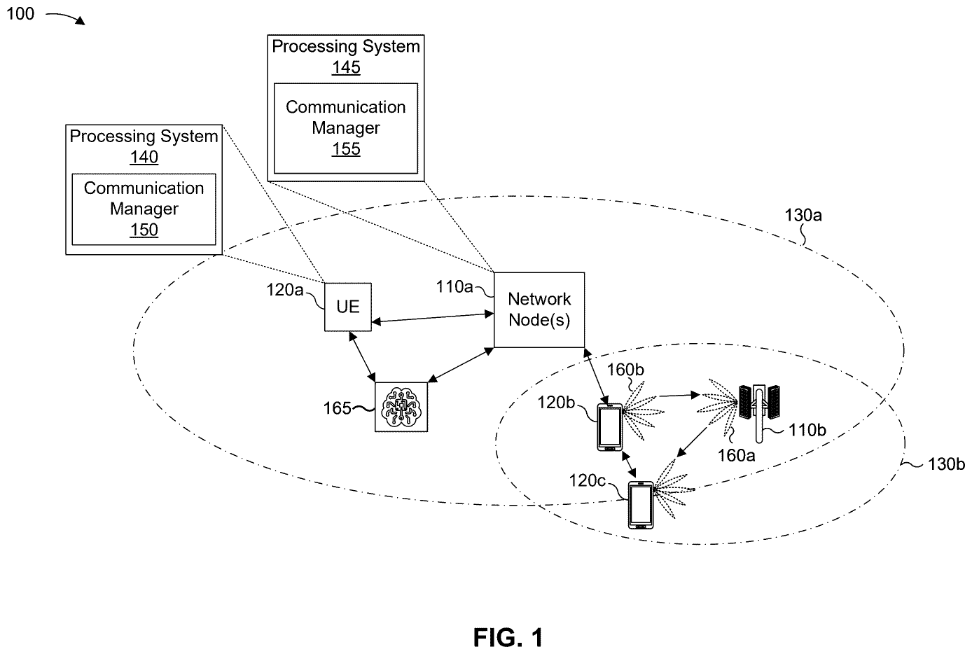

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions. In some examples, the processing system may include or be associated with a communication manager 150.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include PDSCHs. Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the network node 110 may include a communication manager 155. As described in more detail elsewhere herein, the communication manager 155 may transmit, to a set of UEs, configuration information that configures a control region associated with control message transmissions to the set of UEs; perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; and transmit the one or more control messages, respectively, to the one or more UEs in accordance with the one or more scheduling conflict rules. Additionally, or alternatively, the communication manager 155 may perform one or more other operations described herein.

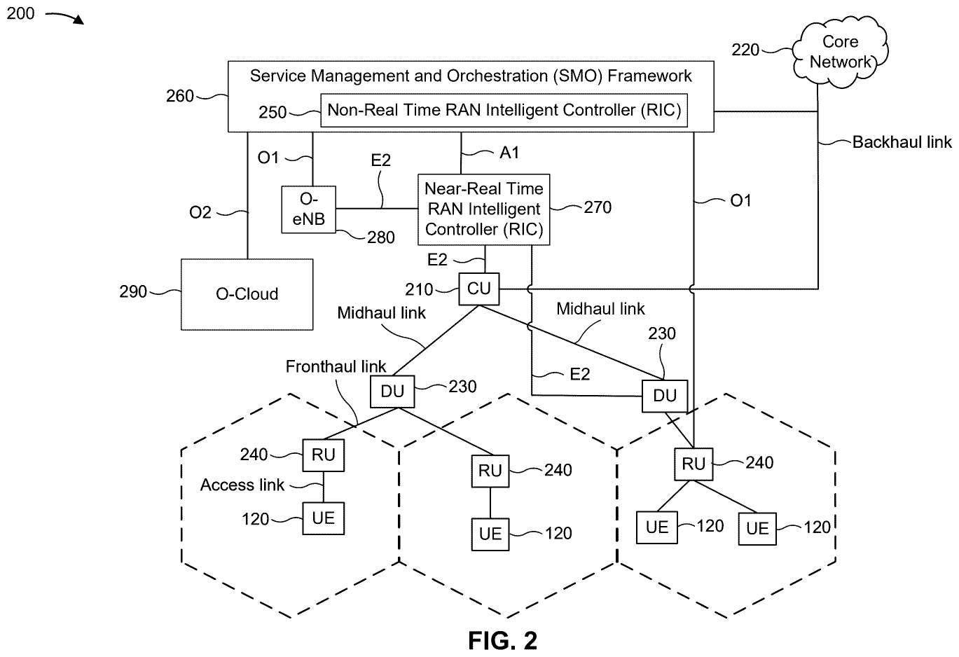

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

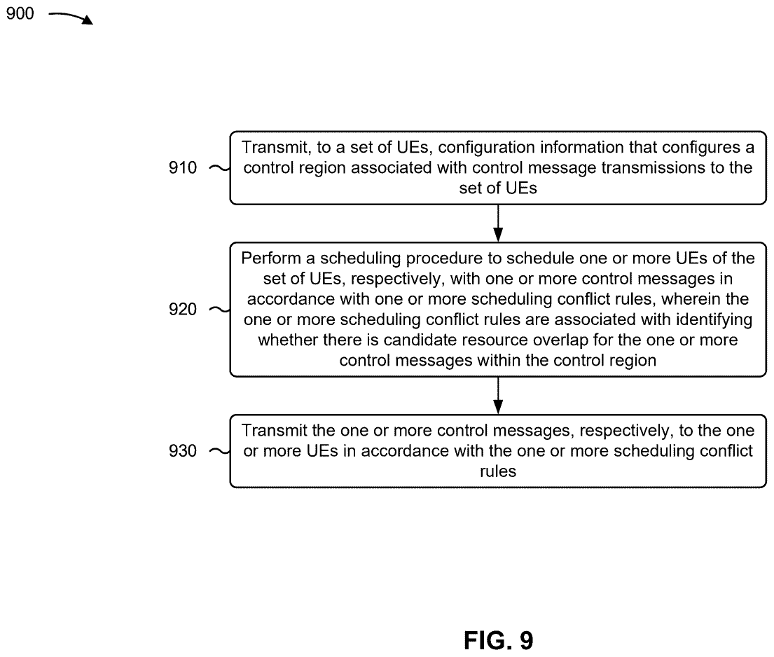

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with resource conflict resolution for control resource selection, as described in more detail elsewhere herein. For example, the processing system 145 of the network node 110, the processing system 140 of the UE 120, the CU 210, the DU 230, or the RU 240 may perform or direct operations of, for example, process 900 of FIG. 9 (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 900 of FIG. 9, or other processes as described herein. In some examples, executing instructions may include running the instructions, converting the instructions, compiling the instructions, or interpreting the instructions, among other examples.

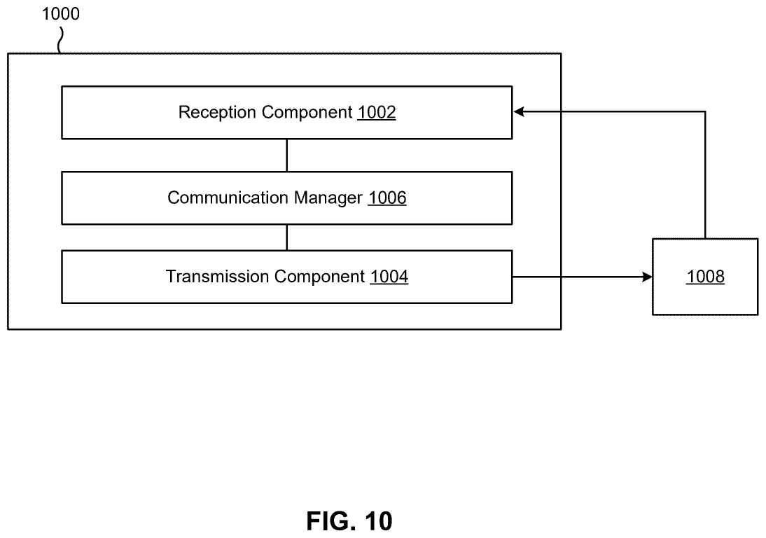

In some aspects, the network node includes means for transmitting, to a set of UEs, configuration information that configures a control region associated with control message transmissions to the set of UEs; means for performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; or means for transmitting the one or more control messages, respectively, to the one or more UEs in accordance with the one or more scheduling conflict rules. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples.

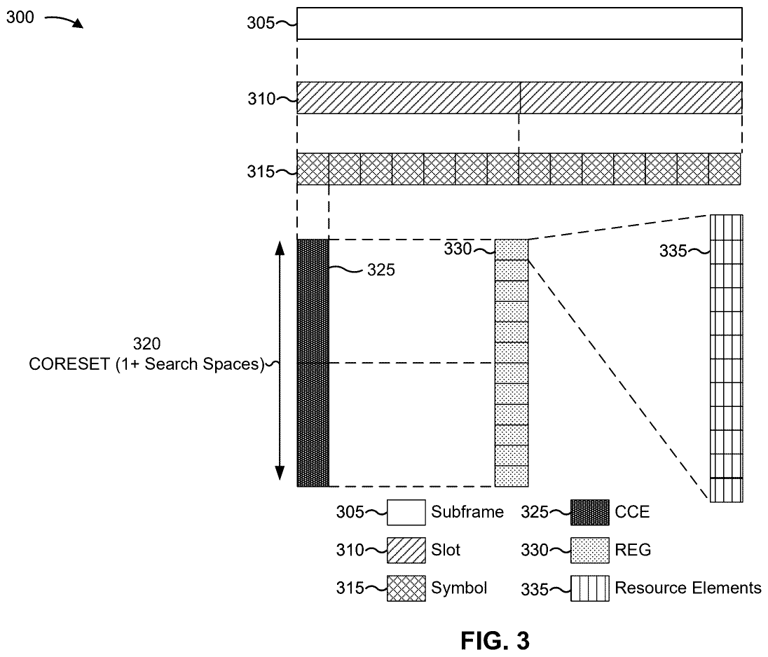

FIG. 3 is a diagram illustrating an example resource structure 300 for wireless communication. Resource structure 300 shows an example of various groups of resources described herein. As shown, resource structure 300 may include a subframe 305. Subframe 305 may include multiple slots 310. While resource structure 300 is shown as including 2 slots per subframe, a different number of slots may be included in a subframe (e.g., 4 slots, 8 slots, 16 slots, 32 slots, or another quantity of slots). In some aspects, different types of transmission time intervals (TTIs) may be used, other than subframes or slots. A slot 310 may include multiple symbols 315, such as 14 symbols per slot.

The potential control region of a slot 310 may be referred to as a CORESET 320 and may be structured to support an efficient use of resources, such as by flexible configuration or reconfiguration of resources of the CORESET 320 for one or more PDCCHs or one or more PDSCHs. In some aspects, the CORESET 320 may occupy the first symbol 315 of a slot 310, the first two symbols 315 of a slot 310, or the first three symbols 315 of a slot 310. Thus, a CORESET 320 may include multiple resource blocks (RBs) in the frequency domain, and either one, two, or three symbols 315 in the time domain. In 5G, a quantity of resources included in the CORESET 320 may be flexibly configured, such as by using radio resource control (RRC) signaling to indicate a frequency domain region (e.g., a quantity of resource blocks) or a time domain region (e.g., a quantity of symbols) for the CORESET 320. In some examples, a control region of a slot (e.g., the CORESET 320) may include time-frequency-code/beam and time-frequency in a single sector or beam. For example, different control regions within the CORESET 320 may be allocated and mapped across time, frequency, spatial, and coding domains.

As illustrated, a symbol 315 that includes CORESET 320 may include one or more control channel elements (CCEs) 325, shown as two CCEs 325 as an example, that span a portion of the system bandwidth. A CCE 325 may include downlink control information (DCI) that is used to provide control information for wireless communication. A network node may transmit DCI during multiple CCEs 325 (as shown), where the quantity of CCEs 325 used for transmission of DCI represents the aggregation level (AL) used by the BS for the transmission of DCI. In FIG. 3, an aggregation level of two is shown as an example, corresponding to two CCEs 325 in a slot 310. In some aspects, different aggregation levels may be used, such as 1, 2, 4, 8, 16, or another aggregation level.

Each CCE 325 may include a fixed quantity of resource element groups (REGs) 330, shown as 6 REGs 330, or may include a variable quantity of REGs 330. In some aspects, the quantity of REGs 330 included in a CCE 325 may be specified by a REG bundle size. A REG 330 may include one resource block, which may include 12 resource elements (REs) 335 within a symbol 315. A resource element 335 may occupy one subcarrier in the frequency domain and one OFDM symbol in the time domain.

A search space may include all possible locations (e.g., in time or frequency) where a PDCCH may be located. A CORESET 320 may include one or more search spaces, such as a UE-specific search space, a group-common search space, or a common search space. A search space may indicate a set of CCE locations where a UE may find PDCCHs that can potentially be used to transmit control information to the UE. The possible locations for a PDCCH may depend on whether the PDCCH is a UE-specific PDCCH (e.g., for a single UE) or a group-common PDCCH (e.g., for multiple UEs) or an aggregation level being used. A possible location (e.g., in time or frequency) for a PDCCH may be referred to as a PDCCH candidate, and the set of all possible PDCCH locations at an aggregation level may be referred to as a search space. For example, the set of all possible PDCCH locations for a particular UE may be referred to as a UE-specific search space. Similarly, the set of all possible PDCCH locations across all UEs may be referred to as a common search space. The set of all possible PDCCH locations for a particular group of UEs may be referred to as a group-common search space. One or more search spaces across aggregation levels may be referred to as a search space (SS) set. In some examples, the search space may define a starting symbol and periodicity of the CCEs.

A CORESET 320 may be interleaved or non-interleaved. An interleaved CORESET 320 may have CCE-to-REG mapping such that adjacent CCEs are mapped to scattered REG bundles in the frequency domain (e.g., adjacent CCEs are not mapped to consecutive REG bundles of the CORESET 320). A non-interleaved CORESET 320 may have a CCE-to-REG mapping such that all CCEs are mapped to consecutive REG bundles (e.g., in the frequency domain) of the CORESET 320.

As indicated above, FIG. 3 is provided as an example. Other examples may differ from what is described with respect to FIG. 3.

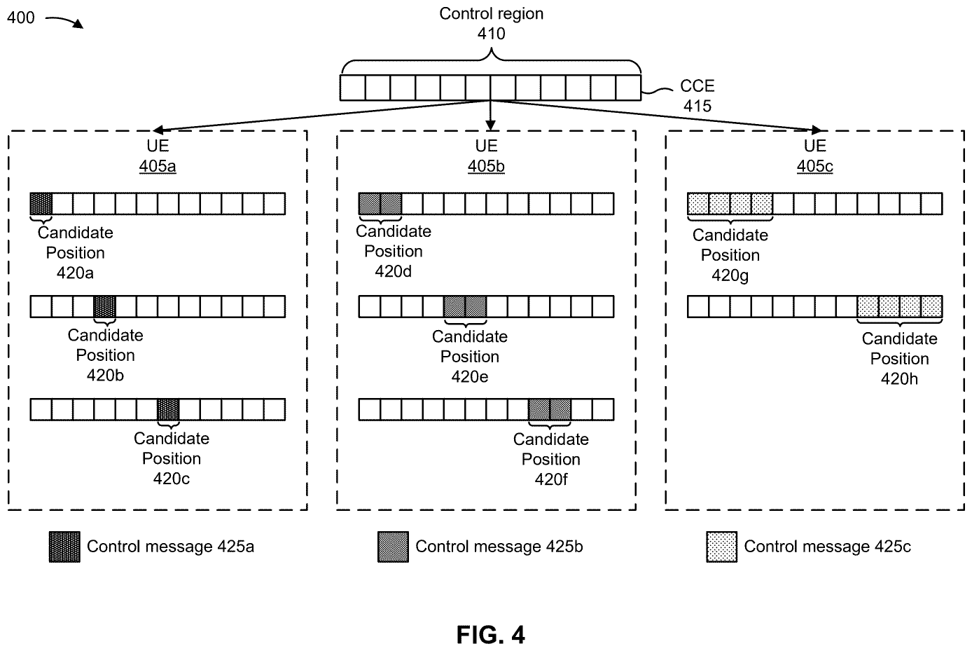

FIG. 4 is a diagram illustrating an example 400 of candidate position generation for transmission of one or more control messages. In some instances, example 400 may implement or be implemented by one or more aspects of FIGS. 1 through 3. For instance, a UE 405a, 405b, and 405c may be respective examples of the UE 120 described elsewhere herein. Additionally, the techniques of example 400 may be associated with a network node 110 determining which resources to use for scheduling multiple control messages 425 to the UEs 405.

In some examples, example 400 may include a control region 410. For example, the control region 410 may include a set of CCEs 415, which may be examples of CCEs 325, with reference to FIG. 3. In some examples, the control region 410 and the set of CCEs 415 may be configured or defined in accordance with an associated CORESET and search space, as described elsewhere herein.

In some examples, a network node 110 may schedule multiple control messages 425 withing the control region 410. For example, the network node 110 may determine to schedule a control message 425a for transmission to the UE 405a, schedule a control message 425b for transmission to the UE 405b, and schedule a control message 425c for transmission to the UE 405c. In some examples, the control messages 425 may be examples of one or more types of control signaling carried by a control channel (e.g., a PDCCH or PDSCH), including one or more of system information (e.g., including a master information block (MIB) signaling or system information block signaling (SIB)), RRC signaling, MAC signaling (e.g., including one or more MAC-CEs), or DCI signaling.

Additionally, the UEs 405 may be configured to monitor for the control messages 425 during the control region 410. However, a given UE 405 may not be aware of an exact time, resource allocation, or location of a control message 425 within the control region 410. Accordingly, the given UE 405 may perform blind decoding, where the given UE 405 may systematically search for possible control message transmissions across different ALs and CCEs 415 within the control region 410. The associated search space may define the potential locations within the CORESET where a PDCCH might carry a control message 425, but the exact position and resource usage may vary depending on network scheduling.

To reduce control-search complexity, a set of candidate positions 420 may be defined within the control region 410 and the given UE 405 may only search within the candidate locations of the control region 410. As described herein, the term “candidate position” may be referred to as a “candidate location,” among other examples. In some examples, the network node 110 and the UEs 405 may determine the potential candidate positions 420 to search for control messages 425 using a hashing function, as described in Equation 1

$$L \cdot \{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i \qquad ( 1 )$$

For example, L may be the AL configured for a given UE 405. For instance, the AL for UE 405a may be one (e.g., one CCE 415 per control message 425), the AL for UE 405b may be two (e.g., two CCEs 415 per control message 425), and the AL for UE 405c may be four (e.g., four CCEs 415 per control message 425). Additionally,

$${Y}_{p , {n}_{s , f}^{μ}}$$

may be a function of a random network temporary identifier (RNTI) associated with a given UE 405 and the slot index associated with the control region 410. Accordingly,

$${Y}_{p , {n}_{s , f}^{μ}}$$

may may be uniquely associated with a UE 405 and may enable different UEs 405 or scheduling occasions to have different CCE allocations. Additionally, m_{s,n}_{_{CI}} may be a number of candidate positions 420 configured for the AL for a given UE 405. For instance, in example 400, the network node 110 may configure the UE 405a with three candidate positions 420, configure the UE 405b with three candidate positions 420, and configure the UE 405c with one candidate position 420. Additionally,

$${M}_{s , max}^{( L )}$$

may be a maximum number of candidate portions 420 for the value L in a search space. Additionally, n_{CI} may be a carrier indicator associated with the control region 410. Additionally, N_{CCE,p} may be the total number of available CCEs 415 in the control region 410 (e.g., 12 with reference to example 400). Additionally, i may be a value of 0 to L−1 that indicates a position within the AL for an associated UE to start searching. Therefore, the hash function described in Equation 1 may provide a structured and randomized allocation mechanism for PDCCH candidates within the control region 410 that distributes control channel resources efficiently while reducing collisions and improving decoding reliability for different ALs. In some examples, one or more of the parameters included in Equation 1 may be explicitly indicated or associated with control signaling transmitted by the network node 110 (e.g., via RRC signaling).

In accordance with Equation 1, the UE 405a may determine to search for a PDCCH transmission, from the network node 110, during candidate position 420a, 420b, and 420c. Accordingly, the network node 110 may transmit the control message 425a during one of candidate position 420a, 420b, or 420c. Additionally, the UE 405b may determine to search for a PDCCH transmission, from the network node 110, during candidate position 420d, 420e, and 420f. Accordingly, the network node 110 may transmit the control message 425b during one of candidate position 420d, 420e, or 420f. Additionally, the UE 405b may determine to search for a PDCCH transmission, from the network node 110, during candidate position 420g and 420h. Accordingly, the network node 110 may transmit the control message 425c during one of candidate position 420g or 420f.

In some examples, the network node 110 may select to transmit the control message 425a, 425c, and 425c during candidate positions 420 that do not have overlapping CCEs 415. For instance, if the network node 110 selects to transmit control message 425a during candidate position 420a, then the network node 110 would not transmit control message 425b during the candidate position 420d or transmit control message 425c during candidate position 420g to avoid overlapping CCEs 415 with the candidate position 420a.

In one example, the network node 110 may transmit control message 425a in accordance with candidate position 420a, transmit control message 425b in accordance with candidate position 420e, and transmit control message 425c in accordance with candidate position 420h. By selecting candidate position 420a, 420e, and 420h the network node 110 may ensure no overlap in CCEs 415 between control message 425a, 425b, and 425c. In a second example, the network node 110 may transmit control message 425a in accordance with candidate position 420c, transmit control message 425b in accordance with candidate position 420d, and transmit control message 425c in accordance with candidate position 420h.

As described herein, the network node 110 may select various combinations of candidate positions 420 within the control region 410 to transmit control message 425a, 425b, and 425c without overlapping CCEs 415 (e.g., a valid combination of candidate positions 420). In some cases, however, the network node 110 determining a valid combination of candidate positions 420 may increase in time and complexity as one or more of a number of control messages 425 or a number of possible candidates per control message increases. Such increases in time and complexity may increase latency associated with wireless transmissions and increase power expenditure at the network node 110.

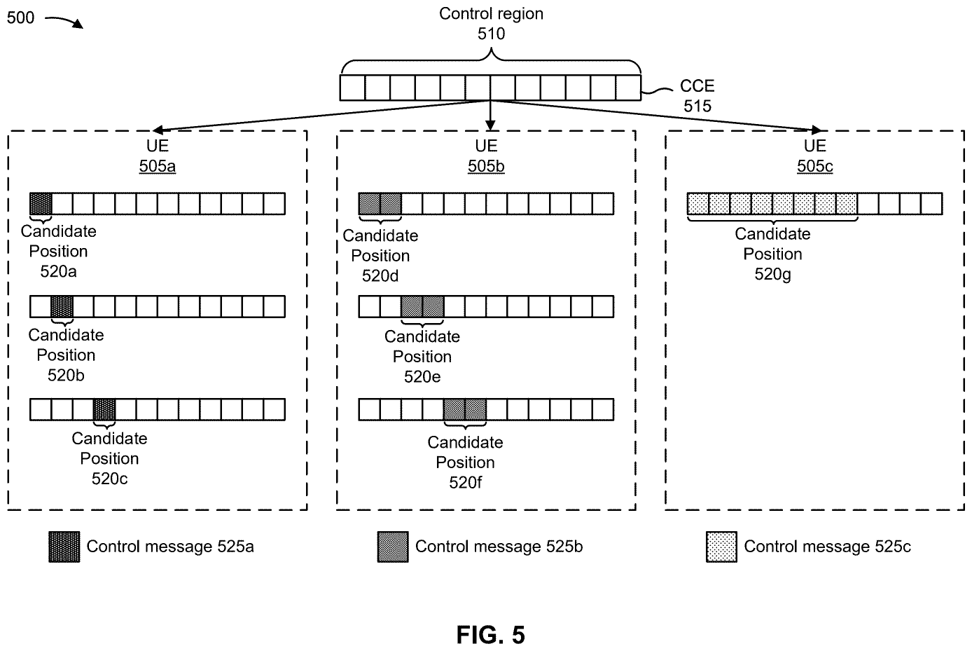

FIG. 5 is a diagram illustrating an example 500 of candidate position generation for transmission of one or more control messages with conflicting resources. In some instances, example 500 may implement or be implemented by one or more aspects of FIGS. 1 through 4. For instance, a UE 505a, 505b, and 505c may be respective examples of the UE 120 described elsewhere herein. Additionally, the techniques of example 500 may be associated with a network node 110 determining which resources to use for scheduling one or more control messages 525 to the UEs 505. Additionally, a control region 510, CCEs 515, candidate positions 520, and control messages 525 may be respective examples of control region 410, CCEs 415, candidate positions 420, and control messages 425, as described with reference to FIG. 4.

In accordance with Equation 1, the UE 505a may determine to search for a PDCCH transmission, from the network node 110, during candidate position 520a, 520b, and 520c. Accordingly, the network node 110 may transmit a control message 525a during one of candidate position 520a, 520b, or 520c. Additionally, the UE 505b may determine to search for a PDCCH transmission, from the network node 110, during candidate position 520d, 520e, and 520f. Accordingly, the network node 110 may transmit a control message 525b during one of candidate position 520d, 520e, or 520f. Additionally, the UE 505b may determine to search for a PDCCH transmission, from the network node 110, during candidate position 520g. Accordingly, the network node 110 may transmit a control message 525c during the candidate position 520g.

In some examples, the network node 110 may be unable to transmit the control message 525a, 525c, and 525c during candidate positions 520 that do not have overlapping CCEs 515. For instance, candidate position 520g overlaps with candidate position 520a through 520g. In other words, if the network node 110 transmits the control message 525c, then the control message 525c may interfere with transmission of the control message 525a or 525b. Such interference may reduce an ability of the UE 505a, 505b, and 505c to respectively receive or decode control message 525a, 525b, and 525c.

To reduce interference, the network node 110 may determine to drop or postpone one or more first control messages that overlap in the control region 510 with one or more second control messages. In a first example, the network node 110 may transmit control message 525a in accordance with candidate position 520a, transmit control message 525b in accordance with candidate position 520e, and drop or postpone the control message 525c. According to the first example, the network node 110 may attempt to maximize the number of scheduled UEs 505 (e.g., minimize blocking probability). In a second example, the network node 110 may drop or postpone control message 525a, drop or postpone control message 525b, and transmit the control message 525c in accordance with the candidate position 520g. According to the second example, the network node 110 may determine to transmit control message 525c according to a fairness metric. For instance, the control message 525c may be a lower latency transmission compared to the control message 525a and 525b or the control message 525c may be a broadcast transmission that transmits to higher number of UEs 505 compared to the control message 525a and 525b.

As described herein, the network node 110 may select various combinations of candidate positions 520 within the control region 510 to transmit one or more of control message 525a, 525b, and 525c without overlapping CCEs 515 (e.g., a valid combination of candidate positions 520). In some cases, however, the network node 110 determining a valid combination of candidate positions 520 may increase in time and complexity as one or more of a number of control messages 525 or a number of possible candidates per control message increases. Such increases in time and complexity may increase latency associated with wireless transmissions and increase power expenditure at the network node 110.

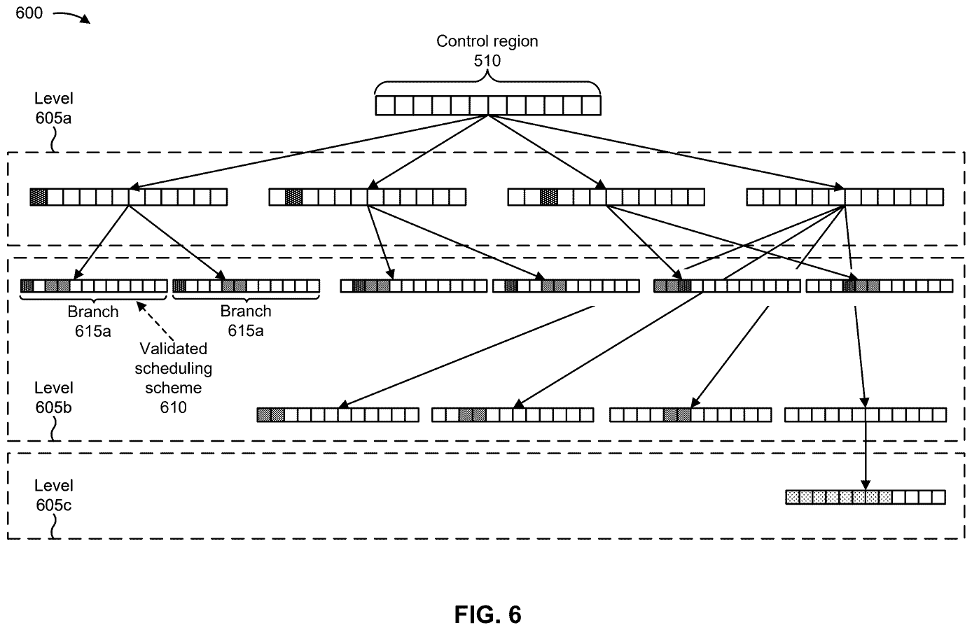

FIG. 6 is a diagram illustrating an example 600 associated with resource conflict resolution between multiple control messages using linear programming. In some instances, example 600 may implement or be implemented by one or more aspects of FIGS. 1 through 5. For instance, example 600 may be an illustrative example of a network node 110 using techniques of linear programming to select candidate positions that reduce a probability of resource conflict between control message 525a, 525b, and 525c.

In some examples, the network node 110 may use one or more linear programming techniques to perform one or more aspects described with reference to example 600. For example, the network node 110 may operate in accordance with one or more of a simplex algorithm, one or more interior-point methods, a branch and bound algorithm, one or more cutting-plane methods, column generation, gradient descent for convex optimization, a dual simplex method, or dynamic programming. Additionally, or alternatively, the network node 110 may operate in accordance with one or more algorithms associated with solving combinatorial problems (e.g., candidate positions that overlap in the control region 510). For example, the one or more algorithms may include one or more of a backtracking algorithm, greedy algorithms, brute-force search, constraint programming, simulated annealing, ant colony optimization, or Monte Carlo tree search. As described herein, example 600 may be associated with the network node 110 performing resource conflict resolution of control messages within the control region 510 using a backtracking algorithm. However, the network node 110 may operate in accordance with any of the linear programming methods or algorithms associated with solving combinatorial problems to perform the techniques described herein.

In some examples, the backtracking algorithm may be used to solve an N-Queens problem. For example, the N-Queens problem may be a combinatorial puzzle that involves placing N queens on an N×N chessboard so that no two queens attack each other. In other words, no two queens can be in the same row, column, or diagonal. The complexity of the N-Queens problem may increase with N, as the number of possible queen placements grows exponentially, making brute-force solutions inefficient.

A common and efficient approach to solving the N-Queens problem may be through using the backtracking algorithm, a depth-first search (DFS)-based technique that incrementally builds a solution while ensuring that parameters of a system are satisfied. For example, the backtracking algorithm places queens row by row, ensuring that each placement does not lead to a conflict. If a valid position is found for a queen in a given row, the algorithm proceeds to place a queen in the next row. However, if no valid position exists for a queen in the current row, the algorithm backtracks to the previous row, moves the previously placed queen to its next valid column, and then continues the search. This recursive approach ensures that all possible valid solutions are explored systematically.

To improve efficiency, the backtracking algorithm may maintain auxiliary data structures to track column usage, diagonal conflicts (left and right diagonals), and row assignments, reducing the number of operations used to check whether a position is valid. Because the N-Queens problem is symmetrical, optimizations like mirroring solutions and pruning unnecessary branches can further speed up execution. Accordingly, the backtracking algorithm may ensures that all valid placements of queens are explored, making the backtracking algorithm an algorithmic technique for solving the N-Queens problem or other combinatorial problems.

Similar, to solving the N-Queens problem, the network node 110 may use the backtracking algorithm to perform conflict resolution between multiple control messages scheduled within the control region 510. For instance, with reference to example 600, the network node 110 may generate one or more levels 605 associated with the backtracking algorithm (e.g., level 605a, 605b, and 605c). For example, the level 605a may be a first level of the backtracking algorithm that is associated with the control message 525a. As shown in FIG. 6, the level 605a may include a first set of candidate positions associated with the control message 525a. For example, the first set of candidate positions includes scheduling the control message 525a at candidate position 520a, at candidate position 520b, at candidate position 520c, or not scheduling the control message 525a.

Accordingly, the network node 110 may use the backtracking algorithm to select a first candidate position from the first set of candidate positions. For instance, the network node 110 may select the candidate position 520a. Based on selecting the first candidate position, the network node 110 may use the backtracking algorithm, to generate one or more first branches from the first candidate position. In some examples, the one or more first branches may be located at the level 605b of the backtracking algorithm (e.g., where the level 605b may be associated with the control message 525b in example 600). For instance, the network node 110 may generate two branches from the candidate position 520a that include a second set of candidate positions of the control message 525b in the control region 510 (e.g., a branch 615a and 615b). As shown in FIG. 6, the branch 615a includes the control message 525b at candidate position 520e while the control message 525a is at candidate position 520a and the branch 615b includes the control message 525b at candidate position 520f while the control message 525a is at candidate position 520a. As shown in FIG. 6, the branch 615a may be a validated scheduling scheme 610. For example, the validated scheduling scheme 610 may be a combination of candidate positions the network node 110 determines to use for transmission of the control messages 525 in accordance with the backtracking algorithm. In some examples, the network node 110 may stop the backtracking algorithm after identifying the validated scheduling scheme 610. For instance, the network node 110 may may be aware that there is no way to schedule the control message 525c without overlapping in the control region 510 with control message 525a and 525b. Therefore, because the branch 615a includes non-overlapping candidate positions for both the control message 525a and 525b, the network node 110 may identify the branch 615a as the validated scheduling scheme 610 and conclude the backtracking algorithm. Accordingly, the network node 110 may transmit the control message 525a in accordance with candidate position 520a and transmit the control message 525b in accordance with candidate position 520e.

In some examples, the network node 110 may select two candidate positions that have a resource overlap (e.g., share one or more of the same CCEs) such that the resource overlap satisfies (e.g., is less than or equal to) a resource overlap threshold. For instance, the network node may identify a branch (not shown) where control message 525a is associated with the candidate position 520a and control message 525b is associated with the candidate position 520d, where the candidate position 520a and the candidate position 520d share one overlapping CCE 515. If, the resource overlap threshold is equal to one CCE, then the network node may be enabled to transmit control message 525a using the candidate position 520a and transmit the control message 525b using the candidate position 520d. The network node 110 may use the resource overlap threshold to enable cases of MU-MIMO or spatial multiplexing of different UEs in different physical spatial locations (e.g., different sectors). For instance, as described elsewhere herein, the control region 510 may include time-frequency-code/beam and time-frequency in a single sector or beam (e.g., control region 510 includes CCEs 515 that are allocated and mapped across one or more of time, frequency, spatial, or coding domains). Because two UEs may be associated with different spatial or coding domains, the network node 110 may use one or more of the same time and frequency resources for transmission to the two UEs without increasing interference. Accordingly, two respective candidate positions selected for respective control messages may include overlapping resources (e.g., share one or more of the same CCEs 515) where the overlap in resources satisfies (e.g., is less than or equal) the resource overlap threshold.

By identifying the validated scheduling scheme 610 using the backtracking algorithm, the network node 110 may successfully identify a scheduling scheme that maximizes the number of control messages scheduled during the control region 510. Additionally, by concluding the backtracking algorithm after identifying the validated scheduling scheme 610, the network node 110 may reduce the time associated with performing the backtracking algorithm, reducing the latency associated with scheduling control messages during the control region 510.

If, however, the first candidate position (e.g., the candidate position 520a) of the set of first candidate positions did not generate any branches 615, then in accordance with the backtracking algorithm, the network node 110 may backtrack to the level 605a and select a second candidate position from the first set of candidate positions associated with the control message 525a. For instance, the network node 110 may select the candidate position 520b. Accordingly, the network node 110 may use the backtracking algorithm to generate a set of branches from the candidate position 520b at the level 605b. As shown in FIG. 6, the network node 110 may recursively backtrack and generate branches from each of the first set of candidate positions at the level 605a. In other words, the network node 110 may use the backtracking algorithm to generate an exhaustive list of all possible combinations of non-overlapping candidate positions until the network node 110 concludes the backtracking algorithm.

Additionally, as shown in FIG. 6, there may be a level 605c under the level 605b. For example, the level 605c may be a third level of the backtracking algorithm that is associated with the control message 525c. As shown in FIG. 6, the level 605a may include one or more candidate positions associated with the control message 525c. For example, the one or more candidate positions include scheduling the control message 525c at candidate position 520g. In other words, the network node 110 may determine to transmit the control message 525c over control message 525a and 525b.

In some examples, the network node 110 may use one or more fairness metrics in addition to the backtracking algorithm to determine the validated scheduling scheme 610. Accordingly, the network node 110 may use the one or more fairness metrics to determine or calculate a weighted value for one or more of the control messages associated with the control region 510. In some examples, the weighted value may be associated with a priority for scheduling a corresponding control message. For example, if a first control message is associated with a first weighted value that is greater than a second weighted value associated with a second control message, then the network node 110 may give a higher priority to transmitting the first control message over transmitting the second control message. Therefore, the network node 110 may use the one or more weighted values associated with the one or more control messages in addition to the backtracking algorithm to determine the validated scheduling scheme 610.

In some examples, the one or more fairness metrics may include a latency metric associated with a control message. For example, a control message may be associated with latency-sensitive applications like ultra-reliable low-latency communication (URLLC), which may include one or more of end-to-end latency, air interface latency, packet delay budget (PDB), HARQ retransmission delay, radio link control (RLC) round-trip time, scheduling delay, processing delay, jitter (latency variation), time-to-first-byte (TTFB), or frame transmission time. Accordingly, the network node 110 may may determine a higher weighted value for a first control message associated with lower latency-sensitive data compared to a second control message.

Additionally, or alternatively, the one or more fairness metrics may include a type of communication (e.g., unicast, groupcast, or broadcast). For instance, a control message that is a groupcast communication or a broadcast communication may be transmitted to more UEs than a control message that is a unicast communication. Accordingly, the network node 110 may determine a higher weighted value for transmission of a broadcast or groupcast control message compared to transmission of a uncast control message.

Additionally, or alternatively, the one or more fairness metrics may include a data payload of the control message. For instance, if a first control message includes a first data payload that is greater than a second data payload of a second control message, then the network node 110 may determine a higher weighted value for transmission of the first control message over transmission of the second control message.

Additionally, or alternatively, the one or more fairness metrics may include a candidate resource size associated with the control message. For instance, if a first control message is associated with a first candidate resource size that is greater than a second candidate resource size of a second control message, then the network node 110 may determine a higher weighted value for transmission of the first control message over transmission of the second control message. Alternatively, if a first control message is associated with a first candidate resource size that is less than a second candidate resource size of a second control message, then the network node 110 may determine a higher weighted value for transmission of the first control message over transmission of the second control message.

Additionally, or alternatively, the one or more fairness metrics may include a transmission priority or a service priority. In some examples, the transmission priority or service priority may be in accordance with one or more characteristics of the UE (e.g., a UE capability, a type of UE, or a type of transmission to the UE, among other examples). For instance, if a first UE is associated with a first level of priority that is greater than a second level or priority associated with a UE, then the network node 110 may determine a higher weighted value for transmission of a first control message to the first UE over transmission of a second control message to a second UE.

As shown in FIG. 6, one or more control messages may be respectively associated with one or more levels 605 of the backtracking algorithm. In some examples, the network node 110 may select which control message is associated with which level 605 based on the weighted value associated with the control messages that the network node 110 determines in accordance with the one or more fairness metrics. In one example, the control message associated with the highest level of the backtracking algorithm (e.g., the level 605a) may be the control message associated with the highest weighted value. In other words, a set of control messages is ordered from highest weighted value to lowest weighted value, and accordingly, may be respectively mapped from highest level 605 to lowest level 605. In some other examples, the association of the one or more control messages with the one or more levels 605 may be random.

The network node 110 may use the backtracking algorithm based on an ease of implementation. For example, the network node 110 may use a number of instructions (such as a number of lines of code) to perform the backtracking algorithm, where the number of instructions satisfies or is below a number threshold. In other words, the amount of storage space used to store and perform the backtracking algorithm may be low, which may reduce memory allocation at the network node 110 for performing resource conflict resolution in the control region 510.

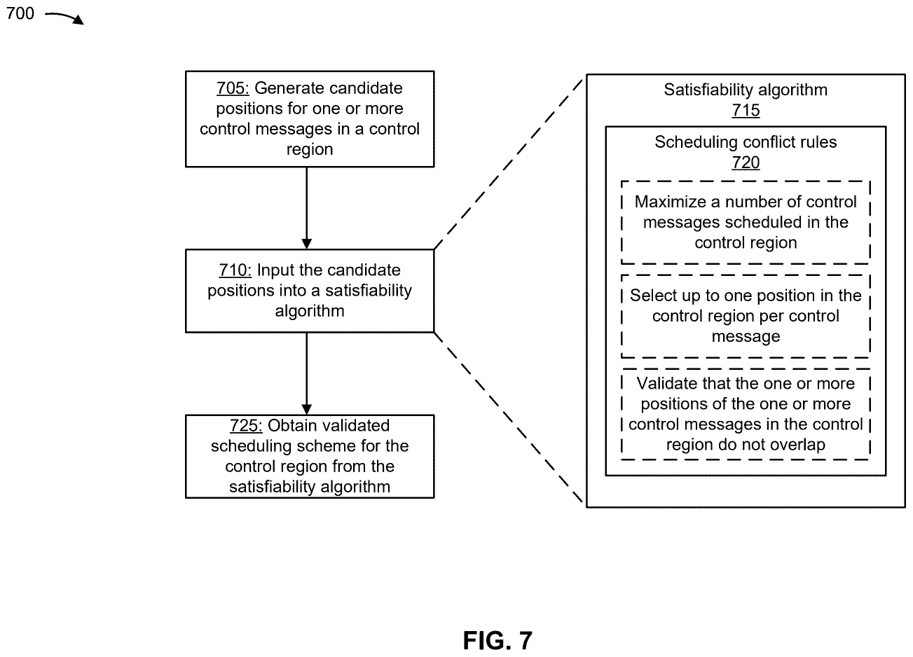

FIG. 7 is a diagram illustrating an example 700 associated with resource conflict resolution between multiple control messages using linear programming. In some instances, example 700 may implement or be implemented by one or more aspects of FIGS. 1 through 6. For instance, example 700 includes one or more operations performed by a network node 110. Alternative examples of the following may be implemented, where some operations are performed in a different order than described, or not described at all. In some cases, one or more operations may include additional features not mentioned below, or further operations may be added.

In a first operation 705, the network node 110 may generate candidate positions for one or more control messages in a control region. For example, the candidate positions may be examples of candidate positions 420 or 520, the control messages may be examples of control messages 425 or 525, and the control region may be an example of control region 410 or 510. In some examples, the network node 110 may generate the candidate positions for the one or more control messages in accordance with Equation 1.

In a second operation 710, the network node 110 may input the candidate positions into a satisfiability algorithm 715. In some examples, the satisfiability algorithm 715 may be a CP-SAT algorithm. For instance, CP-SAT may be a CP solver that combines CP techniques with Boolean satisfiability solving and mixed-integer linear programming (MILP) techniques to efficiently analyze combinatorial optimization problems. In some examples, CP-SAT may leverage techniques such as one or more of constraint propagation, branch and bound, and one or more cutting-plane methods for linear relaxations.

In some examples, CP-SAT may be associated with a rich modeling layer, which allows users to express constraints using linear arithmetic operations and complex discrete optimization structures. For instance, CP-SAT can handle both linear constraints (e.g., inequalities, equalities) and logical constraints (e.g., Boolean satisfiability conditions). Accordingly, CP-SAT may be used to solve problems that involve one or more of integer decision variables, set constraints, logical conditions, or objective functions. Additionally, CP-SAT may support arithmetic constraints (e.g., sums, products, modulo operations), all-different constraints, scheduling constraints, routing constraints, and custom user-defined constraints, allowing for flexible and expressive problem formulations.

In some examples, CP-SAT may be associated with constraint propagation. For example, constraint propagation may be a technique in constraint programming that systematically reduces the search space by enforcing local consistency on constraints. For instance, if a constraint is added or a variable is assigned a value, then constraint propagation attempts to eliminate inconsistent values from the domains of other variables before proceeding further. In some examples, CP-SAT may implement arc-consistency and bound-consistency techniques, ensuring that infeasible values are pruned thereby improving efficiency of the CP-SAT. Therefore, constraint propagation may enable the CP-SAT solver to avoid exploring branches that do not align with the constraints of the CP-SAT, reducing computational overhead and improving convergence towards optimal solutions.

In some examples, the CP-SAT may employ a branch and bound approach to systematically explore the solution space while pruning infeasible regions. In accordance with branch and bound, the CP-SAT solver may recursively branch by making variable assignments, and bounds may be used to eliminate paths that cannot lead to an optimal solution. The CP-SAT solver may select decision variables based on heuristic methods (such as minimum domain size or most constrained variable) to prioritize branches. When a feasible solution is found, CP-SAT may use one or more bounding techniques to refine the solution and search for improvements. Accordingly, the branch and bound method, combined with constraint propagation, enables CP-SAT to efficiently handle large-scale combinatorial problems.

To further enhance performance, CP-SAT may leverage cuts on linear relaxations. For example, linear relaxations may involve converting integer constraints into continuous constraints to provide a lower bound on an associated objective function. Accordingly, the CP-SAT may apply one or more cutting-plane methods, which may iteratively add new constraints (e.g., cuts) to eliminate infeasible integer solutions. Therefore, cutting-plane methods may enable the CP-SAT solver to reduce the solution space and improve convergence towards optimality.

In accordance with the techniques described herein, the network node 110 may use a satisfiability algorithm 715 (e.g., a CP-SAT solver), where the satisfiability algorithm 715 may be associated with or defined by one or more scheduling conflict rules 720 (e.g., constraints applied to the CP-SAT solver). For example, the one or more scheduling conflict rules 720 may enable the network node 110 to use the satisfiability algorithm 715 to determine how to schedule one or more control messages in the associated control region.

In some examples, the one or more scheduling conflict rules 720 may be associated with maximizing a number of control messages scheduled in the control region, in accordance with Equation 2:

$$max {\sum }_{i} {y}_{i} \qquad ( 2 )$$

With reference to Equation 2, the variable i may be the total number of control messages the network node 110 could transmit in the control region. Additionally, the variable yᵢ for each control message may be a value of ‘0’ or ‘1’. For example, a value of ‘1’ may indicate that the associated control message is to be scheduled in the control region, and a value of ‘0’ may indicate that the associated control message is not scheduled in the control region. In other words, Equation 2 indicates that the satisfiability algorithm 715 should maximize the total number of control messages the network node 110 transmits in the control region.

In some examples, the one or more scheduling conflict rules 720 may be associated with selecting up to one candidate position in the control region per control message, in accordance with Equation 3:

$$s . t . {y}_{i} , {x}_{i , j} ∈ \{ 1 , 0 \} \qquad ( 3 )$$

$$0 \leq {\sum }_{j} {x}_{i , j} = {y}_{i} , ∀ i$$

With reference to Equation 3, the variable x_{i,j} may indicate the j-th candidate position within the control region for the i-th control message. In some examples, the variable x_{i,j} may be a value of ‘0’ or ‘1’. For example, a value of ‘1’ may indicate that the associated candidate position for the control message is selected, and a value of ‘0’ may indicate that the associated candidate position for the control message is not selected. In other words, Equation 3 indicates that the satisfiability algorithm 715 should allow up to one candidate position per control message scheduled in the control region. For instance, with reference to example 500, up to one of candidate position 520a, 520b, and 520c may be selected for the control message 525a.

In some examples, the one or more scheduling conflict rules 720 may be associated with validating that the one or more candidate positions of the one or more control messages do not overlap, in accordance with Equation 4:

$$Overlap ( {x}_{i , j} , {x}_{k , l} ) = False , ∀ i , j , k , l \qquad ( 4 )$$

With reference to Equation 4, x_{k,l} may may indicate the l-th candidate position within the control region for the k-th control message, such that if x_{i,j}=1 and x_{k,l}=1, then the candidate position associated with x_{i,j} may not overlap with the candidate position associated with x_{k,l}. In other words, Equation 4 indicates that the satisfiability algorithm 715 should ensure that no two respective candidate positions selected for respective control messages include overlapping resources (e.g., share any of the same CCEs).

In some examples, Equation 4 indicates that the that the satisfiability algorithm 715 should ensure that if x_{i,j}=1 and x_{k,l}=1, then any overlap between x_{i,j} and x_{k,l} may satisfy a resource overlap threshold. In other words, multiple candidate positions respectively associated with multiple control messages are associated with a resource overlap that satisfies the resource overlap threshold. For example, the network node 110 may use the resource overlap threshold to enable cases of MU-MIMO or spatial multiplexing of different UEs in different physical spatial locations (e.g., different sectors). For instance, as described elsewhere herein, the control region may include time-frequency-code/beam and time-frequency in a single sector or beam (e.g., control region includes CCEs that are allocated and mapped across one or more of time, frequency, spatial, or coding domains). Because two UEs may be associated with different spatial or coding domains, the network node 110 may use one or more of the same time and frequency resources for transmission to the two UEs without increasing interference. Accordingly, two respective candidate positions selected for respective control messages may include overlapping resources (e.g., share one or more of the same CCEs) where the overlap in resources satisfies (e.g., is less than or equal) the resource overlap threshold.

In a third operation 725, the network node 110 may obtain a validated scheduling scheme for the control region from the satisfiability algorithm 715 in accordance with the one or more scheduling conflict rules 720. For example, the validated scheduling scheme may include one or more candidate positions (that satisfy the scheduling conflict rules 720) for respective transmission of one or more control messages.

In some examples, the network node 110 may use one or more fairness metrics in addition to the satisfiability algorithm 715 to determine the validated scheduling scheme. Accordingly, the network node 110 may use the one or more fairness metrics to determine or calculate a weighted value for one or more of the control messages associated with the control region. In some examples, the one or more fairness metrics may be the same as described elsewhere herein, such as with reference to FIG. 6 (e.g., one or more of a priority for scheduling a corresponding control message, a latency metric, a type of communication, a data payload of the control message, or a candidate resource size).

The network node 110 may use the satisfiability algorithm 715 to determine a validated scheduling scheme for the control region based on the satisfiability algorithm 715 being associated with polynomial scaling. For example, the network node 110 may perform the satisfiability algorithm 715 in a time of “O(n^{k})”, where n is the input size, and k is a constant. Polynomial scaling may be more efficient than exponential scaling (e.g., “O(2ⁿ)” or “O(n!)”) enabling the satisfiability algorithm 715 to determine the validated scheduling scheme at a faster rate compared to other types of combinatorial algorithms. In other words, the satisfiability algorithm 715 may enable a reduction in latency for the network node 110 scheduling control messages in the control region while managing candidate position conflict resolution.

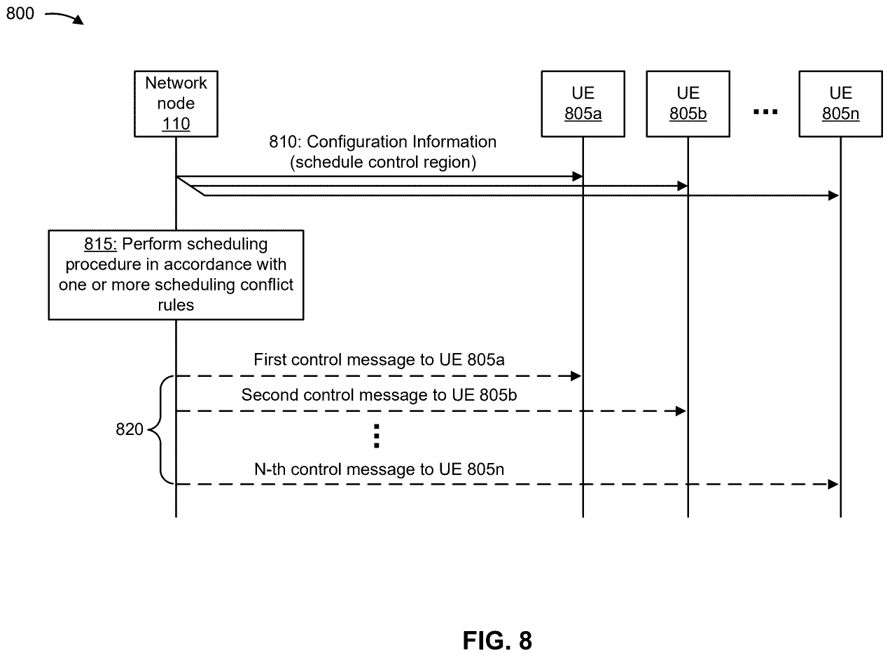

FIG. 8 is a diagram illustrating an example 800 associated with operations that enable resource conflict resolution for control resource selection. Example 800 may implement or be implemented by one or more aspects of FIGS. 1 through 7. For instance, example 800 includes wireless communications between the network node 110 and a set of UEs 805 (e.g., a UE 805a, 805b, and 805n). In some examples, UE 805a through 805n may represent any number of UEs 120 that are serviced by the network node 110. Alternative examples of the following may be implemented, where some operations are performed in a different order than described, or not described at all. In some cases, one or more operations may include additional features not mentioned below, or further operations may be added. In addition, while example 800 shows operations between the set of UEs 805 and the network node 110, the communication may occur between any number of network devices of various types described herein.

In a first operation 810, the network node 110 may transmit, and the UEs 805 may receive, configuration information. In some aspects, the UE 120 may receive the configuration information via one or more of system information signaling (e.g., a master information block (MIB) or a SIB, among other examples), RRC signaling, MAC signaling (e.g., one or more MAC-CEs), or DCI, among other examples. In some examples, the configuration information may include separate signaling to separate UEs 805 (e.g., unicast) or a signaling to multiple UEs 805 (e.g., broadcast or unicast).

In some aspects, the configuration information may indicate one or more candidate configurations or communication parameters. In some aspects, the one or more candidate configurations or communication parameters may be selected, activated, or deactivated by a subsequent indication. For example, the subsequent indication may indicate a candidate configuration or communication parameter from the one or more candidate configurations or communication parameters. In some aspects, the subsequent indication may include a dynamic indication, such as one or more MAC-CEs or one or more DCI messages, among other examples.

In some examples, the configuration information may not be expressly signaled to the UEs 805. For example, in some aspects, the configuration information may at least partially be defined by a wireless communication standard, such as the 3GPP. In such examples, the network node 110 may not explicitly indicate such configuration information to the UEs 805. For example, a given UE 805 may optionally obtain at least a portion of the configuration information from a configuration stored by the given UE 805 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some examples, the configuration information may configure a control region (e.g., control region 410 or 510) associated with control message transmissions to the set of UEs 805, as described elsewhere herein.

In a second operation 815, the network node 110 may perform a scheduling procedure to schedule one or more UEs 805 of the set of UEs 805 with one or more control messages (e.g., control messages 425 or 525). For example, the scheduling procedure may be in accordance with one or more scheduling conflict rules, where the one or more scheduling conflict rules may be associated with identifying whether there is candidate resource overlap for the one or more control messages within the control region.

In some examples, the scheduling procedure and the one or more scheduling conflict rules are associated with one or more fairness metrics for resource selection in the control region, as described elsewhere herein. For example, as part of the scheduling procedure, the network node 110 may optionally generate a first weighted value for a first control message of the one or more control messages and a second weighted value for a second control message of the one or more control messages in accordance with the one or more fairness metrics, where the first weighted value is greater than the second weighted value. Accordingly, the scheduling procedure may prioritize resource selection of the first control message over the second control message based on the first weighted value being greater than the second weighted value. The one or more fairness metrics may include one or more of a latency metric associated with a control message, whether the control message is associated with unicast or broadcast communication, a data payload of the control message, a candidate resource size associated with the control message, or a transmission priority or a service priority associated with the control message.

Additionally, or alternatively, the scheduling procedure and the one or more scheduling conflict rules may be associated with a backtracking algorithm (e.g., with reference to FIG. 6). For instance, in a first example, the one or more control messages may include a first control message associated with one or more first candidate resource sets and a second control message associated with one or more second candidate resource sets. In such a first example, the network node 110 may generate, at a first level (e.g., the level 605a) of the backtracking algorithm that is associated with the first control message, a first set of candidate positions of the first control message in the control region based on the one or more first candidate resource sets. The network node 110 may select a first candidate position of the first control message from the first set of candidate positions. The network node 110 may generate, at a second level (e.g., the level 605b) of the backtracking algorithm that may be associated with the second control message, one or more first branches (e.g., branches 615) from the first candidate position of the first control message, where the one or more first branches may include a second set of candidate positions of the second control message in the control region while the first control message is at the first candidate position. Accordingly, the network node 110 may validate whether any of the one or more first branches include the first control message and the second control message in non-overlapping positions in the control region.

With reference to the first example, a branch of the one or more first branches may include the first control message at a first position in the control region and the second control message at a second position in the control region, where the first position and the second position are associated with a resource overlap that satisfies a resource overlap threshold, as described elsewhere herein. In such examples, the network node 110 may determine the branch to be a validated scheduling scheme (e.g., the validated scheduling scheme 610). In some examples, to satisfy the resource overlap threshold, the first position is non-overlapping with the second position in the control region.

Alternatively, with reference to the first example, no branch of the one or more first branches may include the first control message and the second control message in non-overlapping positions of the control region. In such examples, the network node 110 may continue performing the scheduling procedure in accordance with the backtracking algorithm. For example, the network node 110 may select a second candidate position of the first control message from the first set of candidate positions. The network node 110 may continue by generating, at the second level of the backtracking algorithm, one or more second branches from the second candidate position of the first control message, where the one or more second branches may include the second set of candidate positions of the second control message in the control region while the first control message is at the second candidate position. Accordingly, the network node 110 may validate whether any of the one or more second branches include the first control message and the second control message in non-overlapping positions in the control region.

Additionally, or alternatively, the scheduling procedure and the one or more scheduling conflict rules may be associated with a satisfiability algorithm (e.g., the satisfiability algorithm 715, with reference to FIG. 7). In such examples, the one or more scheduling conflict rules may include maximizing a number of control messages from the one or more control messages scheduled in the control region (e.g., Equation 2), selecting one position in the control region for control messages associated with multiple candidate positions in the control region (e.g., Equation 3), and validating that the one or more control messages are respectively associated with one or more positions in the control region associated with a resource overlap that satisfies a resource overlap threshold (e.g., Equation 4). In some examples, to satisfy the resource overlap threshold, the one or more positions may be non-overlapping in the control region.

In a third operation 820, the network node 110 may transmit the one or more control messages, respectively, to the one or more UEs 805 in accordance with the one or more scheduling conflict rules. For example, the network node 110 may optionally transmit, and the UE 805a may receive, a first control message in accordance with the scheduling procedure. Additionally, or alternatively, the network node 110 may optionally transmit, and the UE 805b may receive, a second control message in accordance with the scheduling procedure. Additionally, or alternatively, the network node 110 may optionally transmit, and the UE 805n may receive, an N-th control message in accordance with the scheduling procedure.

FIG. 9 is a diagram illustrating an example process 900 performed, for example, at a network node or an apparatus of a network node. Example process 900 is an example where the apparatus or the network node (e.g., network node 110) performs operations associated with resource conflict resolution for control resource selection.

As shown in FIG. 9, in some aspects, process 900 may include transmitting, to a set of UEs, configuration information that configures a control region associated with control message transmissions to the set of UEs (block 910). For example, the network node (e.g., using transmission component 1004 or communication manager 1006, depicted in FIG. 10) may transmit, to a set of UEs, configuration information that configures a control region associated with control message transmissions to the set of UEs, as described above.

As further shown in FIG. 9, in some aspects, process 900 may include performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region (block 920). For example, the network node (e.g., using communication manager 1006, depicted in FIG. 10) may perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region, as described above. In some examples, the network node may perform the scheduling procedure based at least in part on a backtracking algorithm. In some examples, the network node may perform the scheduling procedure based at least in part on a satisfiability algorithm. In some examples, the network node may perform the scheduling procedure based at least in part on one or more fairness metrics.

As further shown in FIG. 9, in some aspects, process 900 may include transmitting the one or more control messages, respectively, to the one or more UEs in accordance with the one or more scheduling conflict rules (block 930). For example, the network node (e.g., using transmission component 1004 or communication manager 1006, depicted in FIG. 10) may transmit the one or more control messages, respectively, to the one or more UEs in accordance with the one or more scheduling conflict rules, as described above.

Process 900 may include additional aspects, such as any single aspect or any combination of aspects described below or in connection with one or more other processes described elsewhere herein.

In a first aspect, the scheduling procedure and the one or more scheduling conflict rules are associated with one or more fairness metrics for resource selection in the control region.

In a second aspect, alone or in combination with the first aspect, the scheduling procedure comprises generating a first weighted value for a first control message of the one or more control messages and a second weighted value for a second control message of the one or more control messages in accordance with the one or more fairness metrics, wherein the first weighted value is greater than the second weighted value, and the scheduling procedure prioritizes resource selection of the first control message over the second control message based at least in part on the first weighted value being greater than the second weighted value.

In a third aspect, alone or in combination with one or more of the first and second aspects, the one or more fairness metrics comprise one or more of a latency metric associated with a control message, whether the control message is associated with unicast or broadcast communication, a data payload of the control message, a candidate resource size associated with the control message, or a transmission priority or a service priority associated with the control message.

In a fourth aspect, alone or in combination with one or more of the first through third aspects, the scheduling procedure and the one or more scheduling conflict rules are associated with a backtracking algorithm.

In a fifth aspect, alone or in combination with one or more of the first through fourth aspects, the one or more control messages include a first control message associated with one or more first candidate resource sets and a second control message associated with one or more second candidate resource sets, the scheduling procedure comprising generating, at a first level of the backtracking algorithm that is associated with the first control message, a first set of candidate positions of the first control message in the control region based at least in part on the one or more first candidate resource sets, selecting a first candidate position of the first control message from the first set of candidate positions, generating, at a second level of the backtracking algorithm that is associated with the second control message, one or more first branches from the first candidate position of the first control message, wherein the one or more first branches include a second set of candidate positions of the second control message in the control region while the first control message is at the first candidate position, and validating whether any of the one or more first branches include the first control message and the second control message in non-overlapping positions in the control region.

In a sixth aspect, alone or in combination with one or more of the first through fifth aspects, a branch of the one or more first branches includes the first control message at a first position in the control region and the second control message at a second position in the control region, wherein the first position and the second position are associated with a resource overlap that satisfies a resource overlap threshold, and transmitting the one or more control messages further comprises transmitting, to a first UE of the one or more UEs, the first control message at the first position in the control region, and transmitting, to a second UE of the one or more UEs, the second control message at the second position in the control region.

The method of claim 7, wherein, to satisfy the resource overlap threshold, the first position is non-overlapping with the second position in the control region.

In a seventh aspect, alone or in combination with one or more of the first through sixth aspects, no branch of the one or more first branches includes the first control message and the second control message in non-overlapping positions of the control region, the scheduling procedure comprising selecting a second candidate position of the first control message from the first set of candidate positions, generating, at the second level of the backtracking algorithm, one or more second branches from the second candidate position of the first control message, wherein the one or more second branches include the second set of candidate positions of the second control message in the control region while the first control message is at the second candidate position, and validating whether any of the one or more second branches include the first control message and the second control message in non-overlapping positions in the control region.

In an eighth aspect, alone or in combination with one or more of the first through seventh aspects, the scheduling procedure and the one or more scheduling conflict rules are associated with a satisfiability algorithm.

In a ninth aspect, alone or in combination with one or more of the first through eighth aspects, the one or more scheduling conflict rules include maximizing a number of control messages from the one or more control messages scheduled in the control region, selecting one position in the control region for control messages associated with multiple candidate positions in the control region, and validating that the one or more control messages are respectively associated with one or more positions in the control region associated with a resource overlap that satisfies a resource overlap threshold.

The method of claim 11, wherein, to satisfy the resource overlap threshold, the one or more positions are non-overlapping in the control region.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a network node, or a network node may include the apparatus 1000. In some aspects, the apparatus 1000 includes a reception component 1002, a transmission component 1004, or a communication manager 1006, which may be in communication with one another (for example, via one or more buses or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 3 through 8. Additionally, or alternatively, the apparatus 1000 may be configured to perform one or more processes described herein, such as process 900 of FIG. 9. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 or the transmission component 1004 may include or may be included in a network interface. The network interface may be configured to obtain or output signals for the apparatus 1000 via one or more communications links, such as a backhaul link, a midhaul link, or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 or the transmission component 1004. For example, the communication manager 1006 may receive information associated with configuring reception of communications by the reception component 1002 or transmission of communications by the transmission component 1004. Additionally, or alternatively, the communication manager 1006 may generate or provide control information to the reception component 1002 or the transmission component 1004 to control reception or transmission of communications.

The transmission component 1004 may transmit, to a set of UEs, configuration information that configures a control region associated with control message transmissions to the set of UEs. The communication manager 1006 may perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region. The transmission component 1004 may transmit the one or more control messages, respectively, to the one or more UEs in accordance with the one or more scheduling conflict rules.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a network node, comprising: transmitting, to a set of user equipments (UEs), configuration information that configures a control region associated with control message transmissions to the set of UEs; performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; and transmitting the one or more control messages, respectively, to the one or more UEs in accordance with the one or more scheduling conflict rules.

Aspect 2: The method of Aspect 1, wherein the scheduling procedure and the one or more scheduling conflict rules are associated with one or more fairness metrics for resource selection in the control region.

Aspect 3: The method of Aspect 2, wherein the scheduling procedure comprises: generating a first weighted value for a first control message of the one or more control messages and a second weighted value for a second control message of the one or more control messages in accordance with the one or more fairness metrics, wherein the first weighted value is greater than the second weighted value, and wherein the scheduling procedure prioritizes resource selection of the first control message over the second control message based at least in part on the first weighted value being greater than the second weighted value.

Aspect 4: The method of Aspect 2, wherein the one or more fairness metrics comprise one or more of: a latency metric associated with a control message, whether the control message is associated with unicast or broadcast communication, a data payload of the control message, a candidate resource size associated with the control message, or a transmission priority or a service priority associated with the control message.

Aspect 5: The method of any of Aspects 1-4, wherein the scheduling procedure and the one or more scheduling conflict rules are associated with a backtracking algorithm.

Aspect 6: The method of Aspect 5, wherein the one or more control messages include a first control message associated with one or more first candidate resource sets and a second control message associated with one or more second candidate resource sets, the scheduling procedure comprising: generating, at a first level of the backtracking algorithm that is associated with the first control message, a first set of candidate positions of the first control message in the control region based at least in part on the one or more first candidate resource sets; selecting a first candidate position of the first control message from the first set of candidate positions; generating, at a second level of the backtracking algorithm that is associated with the second control message, one or more first branches from the first candidate position of the first control message, wherein the one or more first branches include a second set of candidate positions of the second control message in the control region while the first control message is at the first candidate position; and validating whether any of the one or more first branches include the first control message and the second control message in non-overlapping positions in the control region.

Aspect 7: The method of Aspect 6, wherein a branch of the one or more first branches includes the first control message at a first position in the control region and the second control message at a second position in the control region, wherein the first position and the second position are associated with a resource overlap that satisfies a resource overlap threshold, and wherein transmitting the one or more control messages further comprises: transmitting, to a first UE of the one or more UEs, the first control message at the first position in the control region; and transmitting, to a second UE of the one or more UEs, the second control message at the second position in the control region.

Aspect 8: The method of Aspect 7, wherein, to satisfy the resource overlap threshold, the first position is non-overlapping with the second position in the control region.

Aspect 9: The method of Aspect 6, wherein no branch of the one or more first branches includes the first control message and the second control message in non-overlapping positions of the control region, the scheduling procedure comprising: selecting a second candidate position of the first control message from the first set of candidate positions; generating, at the second level of the backtracking algorithm, one or more second branches from the second candidate position of the first control message, wherein the one or more second branches include the second set of candidate positions of the second control message in the control region while the first control message is at the second candidate position; and validating whether any of the one or more second branches include the first control message and the second control message in non-overlapping positions in the control region.

Aspect 10: The method of any of Aspects 1-9, wherein the scheduling procedure and the one or more scheduling conflict rules are associated with a satisfiability algorithm.

Aspect 11: The method of Aspect 10, wherein the one or more scheduling conflict rules include: maximizing a number of control messages from the one or more control messages scheduled in the control region; selecting one position in the control region for control messages associated with multiple candidate positions in the control region; and validating that the one or more control messages are respectively associated with one or more positions in the control region associated with a resource overlap that satisfies a resource overlap threshold.

Aspect 12: The method of Aspect 11, wherein, to satisfy the resource overlap threshold, the one or more positions are non-overlapping in the control region.

Aspect 13: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-12.

Aspect 14: An apparatus for wireless communication at a device, the apparatus comprising one or more memories and one or more processors coupled to the one or more memories, the one or more processors configured to cause the device to perform the method of one or more of Aspects 1-12.

Aspect 15: An apparatus for wireless communication, the apparatus comprising at least one means for performing the method of one or more of Aspects 1-12.

Aspect 16: A non-transitory computer-readable medium storing code for wireless communication, the code comprising instructions executable by one or more processors to perform the method of one or more of Aspects 1-12.

Aspect 17: A non-transitory computer-readable medium storing a set of instructions for wireless communication, the set of instructions comprising one or more instructions that, when executed by one or more processors of a device, cause the device to perform the method of one or more of Aspects 1-12.

Aspect 18: A device for wireless communication, the device comprising a processing system that includes one or more processors and one or more memories coupled with the one or more processors, the processing system configured to cause the device to perform the method of one or more of Aspects 1-12.

Aspect 19: An apparatus for wireless communication at a device, the apparatus comprising one or more memories and one or more processors coupled to the one or more memories, the one or more processors individually or collectively configured to cause the device to perform the method of one or more of Aspects 1-12.

Aspect 20: A device comprising a processing system that includes one or more processors and one or more code-storing memories coupled with the one or more processors, the processing system configured to cause the device to perform the method of one or more of Aspects 1-12.

Aspect 21: A device comprising a processing system that includes processor circuitry and code-storing memory circuitry, the processing system configured to cause the device to perform the method of one or more of Aspects 1-12.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node for wireless communication, comprising:
one or more memories; and
one or more processors, coupled to the one or more memories, configured to cause the network node to:
transmit, to a set of user equipments (UEs), configuration information that configures a control region associated with control message transmissions to the set of UEs;
perform a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; and
transmit the one or more control messages, respectively, to the one or more UEs in accordance with the one or more scheduling conflict rules.

2. The network node of claim 1, wherein the scheduling procedure and the one or more scheduling conflict rules are associated with one or more fairness metrics for resource selection in the control region.

3. The network node of claim 2, wherein, as part of the scheduling procedure, the one or more processors are further configured to cause the network node to:
generate a first weighted value for a first control message of the one or more control messages and a second weighted value for a second control message of the one or more control messages in accordance with the one or more fairness metrics, wherein the first weighted value is greater than the second weighted value, and wherein the scheduling procedure prioritizes resource selection of the first control message over the second control message based at least in part on the first weighted value being greater than the second weighted value.

4. The network node of claim 2, wherein the one or more fairness metrics comprise one or more of:
a latency metric associated with a control message,
whether the control message is associated with unicast or broadcast communication,
a data payload of the control message,
a candidate resource size associated with the control message, or
a transmission priority or a service priority associated with the control message.

5. The network node of claim 1, wherein the scheduling procedure and the one or more scheduling conflict rules are associated with a backtracking algorithm.

6. The network node of claim 5, wherein the one or more control messages include a first control message associated with one or more first candidate resource sets and a second control message associated with one or more second candidate resource sets, and wherein, as part of the scheduling procedure, the one or more processors are further configured to cause the network node to:
generate, at a first level of the backtracking algorithm that is associated with the first control message, a first set of candidate positions of the first control message in the control region based at least in part on the one or more first candidate resource sets;
select a first candidate position of the first control message from the first set of candidate positions;
generate, at a second level of the backtracking algorithm that is associated with the second control message, one or more first branches from the first candidate position of the first control message, wherein the one or more first branches include a second set of candidate positions of the second control message in the control region while the first control message is at the first candidate position; and
validate whether any of the one or more first branches include the first control message and the second control message in non-overlapping positions in the control region.

7. The network node of claim 6, wherein a branch of the one or more first branches includes the first control message at a first position in the control region and the second control message at a second position in the control region, wherein the first position and the second position are associated with a resource overlap that satisfies a resource overlap threshold, and wherein, to transmit the one or more control messages, the one or more processors are further configured to cause the network node to:
transmit, to a first UE of the one or more UEs, the first control message at the first position in the control region; and
transmit, to a second UE of the one or more UEs, the second control message at the second position in the control region.

8. The network node of claim 7, wherein, to satisfy the resource overlap threshold, the first position is non-overlapping with the second position in the control region.

9. The network node of claim 6, wherein no branch of the one or more first branches includes the first control message and the second control message in non-overlapping positions of the control region, and wherein, as part of the scheduling procedure, the one or more processors are further configured to cause the network node to:
select a second candidate position of the first control message from the first set of candidate positions;
generate, at the second level of the backtracking algorithm, one or more second branches from the second candidate position of the first control message, wherein the one or more second branches include the second set of candidate positions of the second control message in the control region while the first control message is at the second candidate position; and
validate whether any of the one or more second branches include the first control message and the second control message in non-overlapping positions in the control region.

10. The network node of claim 1, wherein the scheduling procedure and the one or more scheduling conflict rules are associated with a satisfiability algorithm.

11. The network node of claim 10, wherein the one or more scheduling conflict rules include:
maximizing a number of control messages from the one or more control messages scheduled in the control region;
selecting one position in the control region for control messages associated with multiple candidate positions in the control region; and
validating that the one or more control messages are respectively associated with one or more positions in the control region associated with a resource overlap that satisfies a resource overlap threshold.

12. The network node of claim 11, wherein, to satisfy the resource overlap threshold, the one or more positions are non-overlapping in the control region.

13. A method of wireless communication performed by a network node, comprising:
transmitting, to a set of user equipments (UEs), configuration information that configures a control region associated with control message transmissions to the set of UEs;
performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; and
transmitting the one or more control messages, respectively, to the one or more UEs in accordance with the one or more scheduling conflict rules.

14. The method of claim 13, wherein the scheduling procedure and the one or more scheduling conflict rules are associated with one or more fairness metrics for resource selection in the control region.

15. The method of claim 14, wherein the scheduling procedure comprises:
generating a first weighted value for a first control message of the one or more control messages and a second weighted value for a second control message of the one or more control messages in accordance with the one or more fairness metrics, wherein the first weighted value is greater than the second weighted value, and wherein the scheduling procedure prioritizes resource selection of the first control message over the second control message based at least in part on the first weighted value being greater than the second weighted value.

16. The method of claim 14, wherein the one or more fairness metrics comprise one or more of:
a latency metric associated with a control message,
whether the control message is associated with unicast or broadcast communication,
a data payload of the control message,
a candidate resource size associated with the control message, or
a transmission priority or a service priority associated with the control message.

17. The method of claim 13, wherein the scheduling procedure and the one or more scheduling conflict rules are associated with a backtracking algorithm.

18. The method of claim 17, wherein the one or more control messages include a first control message associated with one or more first candidate resource sets and a second control message associated with one or more second candidate resource sets, the scheduling procedure comprising:
generating, at a first level of the backtracking algorithm that is associated with the first control message, a first set of candidate positions of the first control message in the control region based at least in part on the one or more first candidate resource sets;
selecting a first candidate position of the first control message from the first set of candidate positions;
generating, at a second level of the backtracking algorithm that is associated with the second control message, one or more first branches from the first candidate position of the first control message, wherein the one or more first branches include a second set of candidate positions of the second control message in the control region while the first control message is at the first candidate position; and
validating whether any of the one or more first branches include the first control message and the second control message in non-overlapping positions in the control region.

19. The method of claim 18, wherein a branch of the one or more first branches includes the first control message at a first position in the control region and the second control message at a second position in the control region, wherein the first position and the second position are associated with a resource overlap that satisfies a resource overlap threshold, and wherein transmitting the one or more control messages further comprises:
transmitting, to a first UE of the one or more UEs, the first control message at the first position in the control region; and
transmitting, to a second UE of the one or more UEs, the second control message at the second position in the control region.

20. An apparatus for wireless communication, comprising:
means for transmitting, to a set of user equipments (UEs), configuration information that configures a control region associated with control message transmissions to the set of UEs;
means for performing a scheduling procedure to schedule one or more UEs of the set of UEs, respectively, with one or more control messages in accordance with one or more scheduling conflict rules, wherein the one or more scheduling conflict rules are associated with identifying whether there is candidate resource overlap for the one or more control messages within the control region; and
means for transmitting the one or more control messages, respectively, to the one or more UEs in accordance with the one or more scheduling conflict rules.
